(19) United States
(12) Patent Application Publication
(10) Pub. No.: US 2017/0111681 A1
(43) Pub. Date: Apr. 20, 2017

(54) Method And Device For Automatically Playing Video List

(71) Applicants: Le Holdings (Beijing) Co., Ltd., Beijing (CN); Le Shi Internet Information Technology Corp. Beijing, Beijing (CN)

(72) Inventor: Wei Jiang, Beijing (CN)

(21) Appl. No.: 15/247,331

(22) Filed: Aug. 25, 2016

Related U.S. Application Data
(63) Continuation of application No. PCT/CN2016/082636, filed on May 19, 2016.

(30) Foreign Application Priority Data
Oct. 15, 2015 (CN) 201510666910.8
May 19, 2016 (CN) PCT/CN2016/082636

(51) Int. Cl. H04N 21/431; H04N 21/482; H04N 5/445

(52) U.S. Cl. CPC H04N 21/4312; H04N 5/44591; H04N 21/4825

(57) ABSTRACT

The present application discloses a method and a device for automatically playing video list. The method includes: when an instruction for opening a video list is detected, displaying the video list, the video list being an interface object for interacting with a user, and including one or more items, and each item including a previewing area; and playing the video of a first item in the previewing area of the first item of the video list, and simultaneously displaying corresponding previewing pictures in the previewing areas of other items. When displaying the video list, the video of a preset item is played in the previewing area of the item, and corresponding previewing pictures are only displayed in other items, so that the occupation of system resources is reduced, and the convenience of previewing video contents is also taken into account.

### CROSS-REFERENCE TO RELATED APPLICATIONS

This application is a continuation of PCT/CN2015/082636 filed May 19, 2016 which claims priority to Chinese Patent Application 201510666910.8, titled “Method and Device for Automatically Playing Video List”, filed on Oct. 15, 2015, the entire contents of all of which are incorporated herein by reference.

### TECHNICAL FIELD

The present disclosure belongs to the field of mobile internet, and more particularly, to a method and a device for automatically playing video list.

### BACKGROUND

The fast growth of the mobile internet population drives the rapid development of related industrial economy, and mobile video is one of more significant products therein. By November 2014, about 70% video events had started using mobile video, and the cumulative year-on-year growth of the year reached 516%. With the increase of 4G users, the popularity of WiFi, the hardware improvement of mobile devices and the continuous optimization of mobile video clients, the mobile videos have also be developed to a ultra high speed development phase, and the competition of mobile video applications has also entered the white-hot stage at the same time. Excluding the attractiveness of the contents to users, skills in the aspect of application experience will play a significant role.

A silent page design will be adopted in a part of mobile video applications of an Android platform at present while showing a live telecast or on-demand video, i.e., image display is default, and a related video can be played only when the video image is clicked; default playing will be adopted by some mobile video applications, i.e., the video of a video list page will be played once the video list page is opened. If the silent page is used, a user has to click to view the playing contents of a certain video when browsing the video list, which is not convenient for the user to preview the video contents. However, if the default playing is adopted blindly, then the selection of the user is ignored, excessive system resources will be occupied, and the network traffic of the user will be wasted.

### SUMMARY

In light of this, the embodiments of the present disclosure provide a method and a device for automatically playing video list, for solving the defects that the displaying of the video list in the prior art does not take into account both the convenience of content previewing and the occupancy rate of the system resources.

In order to solve the foregoing technical problem, the embodiments of the present disclosure disclose a method for automatically playing video list, including: when an instruction for opening a video list is detected, displaying the video list, the video list being an interface object for interacting with a user, and including one or more items, and each item including a previewing area; and playing the video of a first item in the previewing area of the first item of the video list, and simultaneously displaying corresponding previewing pictures in the previewing areas of other items.

In order to solve the foregoing technical problem, the embodiments of the present disclosure also disclose a device for automatically playing video list, including: a display module configured to, when an instruction for opening a video list is detected, display the video list, the video list being an interface object for interacting with a user, and including one or more items, and each item including a previewing area; and a first processing module configured to play the video of a first item in the previewing area of the first item of the video list, and simultaneously display corresponding previewing pictures in the previewing areas of other items.

In order to solve the foregoing technical problem, the embodiments of the present disclosure also disclose a device for automatically playing video list, including: a processor; and a memory for storing instructions executable by the processor; wherein the processor is configured to: when an instruction for opening a video list is detected, display the video list, the video list being an interface object for interacting with a user, and including one or more items, and each item including a previewing area; and play the video of a first item in the previewing area of the first item of the video list, and simultaneously display corresponding previewing pictures in the previewing areas of other items.

Compared with the prior art, the method for automatically playing video list provided by the embodiments of the present disclosure, when displaying the video list, plays the video of a preset item in the previewing area of the item, and only displays corresponding previewing pictures in other items, so that the occupation of system resources is reduced, and the convenience of previewing video contents is also taken into account.

### BRIEF DESCRIPTION OF THE DRAWINGS

In order to explain the technical solutions in the embodiments of the disclosure or in the prior art more clearly, the drawings used in the descriptions of the embodiments or the prior art will be simply introduced hereinafter. It is apparent that the drawings described hereinafter are merely some embodiments of the disclosure, and those skilled in the art may also obtain other drawings according to these drawings without going through creative work.

FIG. 1 is a flow chart of a method for automatically playing video list provided by the embodiment of the present disclosure;

FIG. 2 is an interface diagram of a video list including multiple items according to the embodiment of the present disclosure;

FIG. 3 is a flow chart of a method for automatically playing video list provided by the embodiment of the present disclosure;

FIG. 4 is an interface diagram when items in the video list stop rolling according to the embodiment of the present disclosure;

FIG. 5 is a block diagram of a device for automatically playing video list provided by the embodiment of the present disclosure;

FIG. 6 is a block diagram of the device for automatically playing video list provided by the embodiment of the present disclosure;

FIG. 7 is a block diagram of the device for automatically playing video list provided by the embodiment of the present disclosure; and

FIG. 8 is a block diagram of the device for automatically playing video list provided by the embodiment of the present disclosure.

### EMBODIMENTS

To make the objects, technical solutions and advantages of the embodiments of the present disclosure more clearly, the technical solutions of the present disclosure will be clearly and completely described hereinafter with reference to the embodiments and drawings of the present disclosure. Apparently, the embodiments described are merely partial embodiments of the present disclosure, rather than all embodiments. Other embodiments derived by those having ordinary skills in the art on the basis of the embodiments of the disclosure without going through creative efforts shall all fall within the protection scope of the present disclosure.

In the embodiment of the present disclosure, when displaying the video list, the video of a preset item is displayed in the previewing area of the item, and corresponding previewing pictures are displayed in other items, so that the occupation of system resources is reduced, and the convenience of previewing video contents is also taken into account in the meanwhile. The user may also slide the video list up and down in the screen; when the video list stops sliding, the item slid into the preset display area starts playing video in the previewing area of the item and other items only display corresponding previewing pictures, so that the video of one item is played in the video list only for the user to preview. Moreover, the user may also select to enable and disable the foregoing previewing functions; when the previewing function is disabled, the video list only displays the previewing pictures of each item, provides more selections for the user, and respects the right of selection of the user, so that the friendly degree of the video application is improved.

FIG. 1 is a method for automatically playing video list provided by the embodiment of the present disclosure, which is applied to a terminal device, wherein the terminal device can be a mobile phone, a computer, a digital broadcast terminal, a messaging device, an on-vehicle console, a gaming console, a tablet device, a medical device, an exercise equipment, a personal digital assistant, or the like. As shown in FIG. 1, the method includes the following steps.

In step S101, when an instruction for opening a video list is detected, the video list is displayed, the video list is an interface object for interacting with a user, and includes one or more items, and each item includes a previewing area.

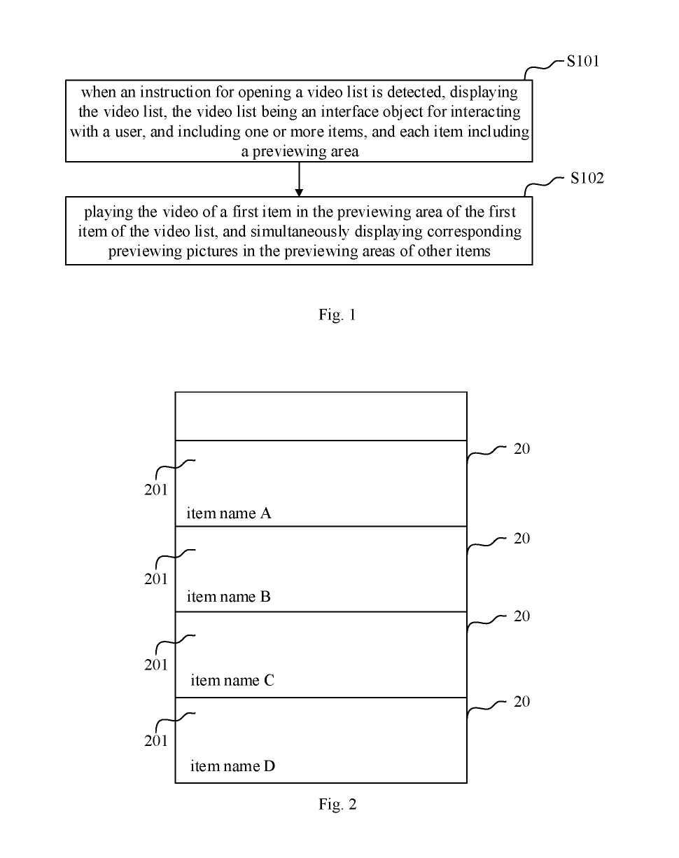

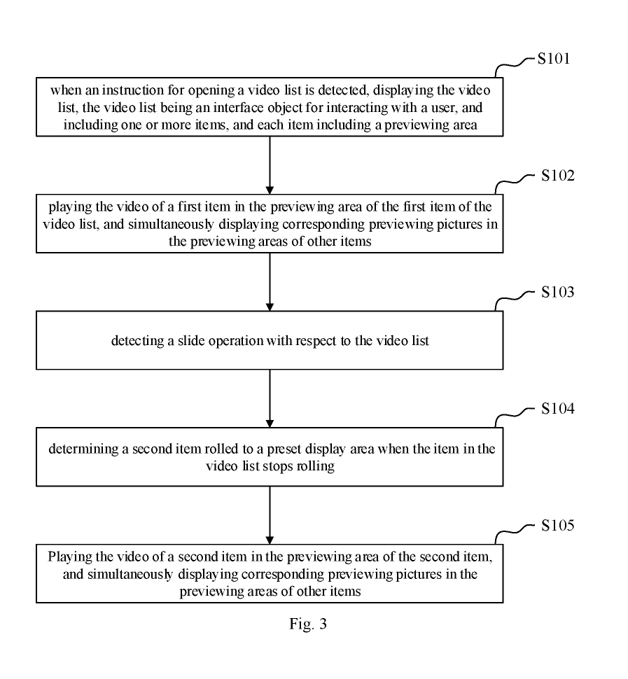

The instruction for opening a video list is from the operation of a user. A terminal equipment requests a corresponding video list from a server and displays the video list. The video list displayed on a screen, as shown in FIG. 2, includes one or more items 20, and each item 20 is corresponding to a video. Each item 20 includes a previewing area 201, wherein the previewing area 201 is configured to display a corresponding video or the previewing picture of the video. Each item 20 may also include such corresponding information of the video as name, hits, or the like.

The video list is an interface object for interacting with the user. The user may open the play pages of the videos corresponding to each item 20 through clicking the previewing area 201 or the name of each item 20, and the user may also roll the item 20 in the video list through a slide gesture in a touch screen.

In step S102, the video of a first item is played in the previewing area of the first item of the video list, and corresponding previewing pictures are simultaneously displayed in the previewing areas of other items.

The first item refers to a preset item in the video list, and may be any item in the video list. When the terminal equipment displays the video list, the video corresponding to the first item is automatically loaded and started playing in the previewing area of the first item; and the previewing pictures of the individual corresponding videos are displayed in the previewing areas of other items at this moment.

In this way, the video of each item will not be directly loaded and played when displaying the video list, and only the video of the first item is loaded and played, so that the occupation of the system resources is reduced; meanwhile, the user is enabled to browse the video corresponding to the first item. Compared with the manner of only displaying the previewing pictures, the convenience of previewing video contents is enhanced; therefore, the two aspects above are both taken into account.

In one embodiment, the first item is the initial item in the video list. When the terminal equipment displays the video list, the video corresponding to the initial item is automatically loaded and played in the previewing area of the initial item; because the user will usually concern the initial item in the list firstly when opening the video list, automatically loading and playing the video corresponding to the initial item enables the user to quickly preview the video corresponding to the item concerned.

FIG. 3 is a method for automatically playing video list provided by the embodiment of the present disclosure applied to a terminal equipment, wherein the method includes the following steps.

In step S101, when an instruction for opening a video list is detected, the video list is displayed, the video list being an interface object for interacting with a user, and including one or more items, and each item including a previewing area.

In step S102, the video of an initial item is played in the previewing area of the initial item of the video list, and corresponding previewing pictures are simultaneously displayed in the previewing areas corresponding to other items.

In step S103, a slide operation with respect to the video list is detected.

The slide operation with respect to the video list is detected by the terminal equipment through monitoring a touch event, and the item in the displayed video list rolls towards the direction of the slide operation.

In step S104, when the item in the video list stops rolling, a second item rolled to a preset display area is determined.

After the item stops rolling, the position of an interface object corresponding to each item displayed in the screen is detected, so as to determine the item currently displayed in the preset display area.

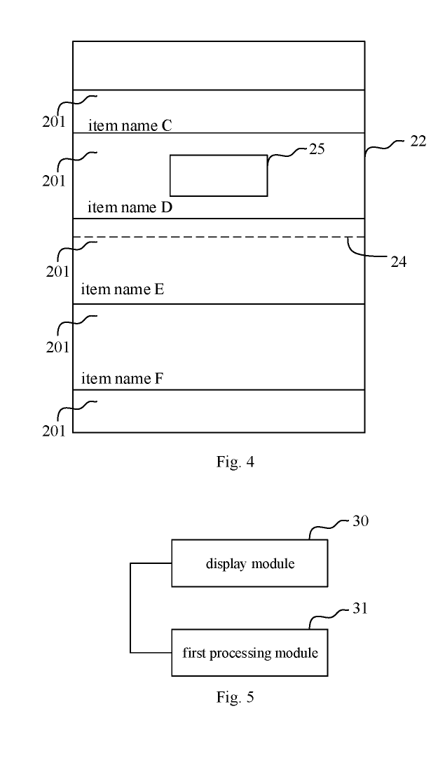

The preset display area is configured to determine the video that needs to be automatically loaded and played. Determining the second item rolled to the preset display area may be that the display area of the interface object of the item in the screen covers the preset display area, and may also be that the display area of the interface object of the item in the screen is located in the preset display area. For example, as shown in FIG. 4, the display area of an item 22 covers a preset display area 25, then the item 22 is determined as the second item rolled to the preset display area.

In step S105, the video of the second item is played in the previewing area of the second item, and corresponding previewing pictures are simultaneously displayed in the previewing areas corresponding to other items.

At this moment, the video corresponding to the second item is played for the user to preview, while the corresponding previewing pictures are displayed in the previewing areas of other items only, so that the video list still plays the corresponding video of one item only; therefore, the conveyance for previewing videos is improved, and the system resources are simultaneously saved.

When the item of the video play list starts rolling, the playing of the video corresponding to the first item is stopped. In the embodiment, when the item of the video play list starts rolling, the playing of the video corresponding to the initial item is stopped immediately, and when the item in the video play list stops rolling, the corresponding video is played in the previewing area of the second item. In addition, the corresponding video may also be played in the previewing area of the second item and the playing of the video corresponding to the first item may also be simultaneously stopped when the item of the video play list stops rolling.

In one embodiment, as shown in FIG. 4, the preset display area 25 is arranged above the transverse middle line 24 of the screen, i.e., arranged above the middle position of the screen. The reasons for such arrangement are as follows: when people are viewing the screen, the sights thereof usually rest on the middle upper part of the screen; therefore, people usually shoot and record important contents on the middle upper part of a frame when shooting or recording a video program. Therefore, the preset display area 25 is also arranged in the middle upper part of the screen in the embodiment, to play the video corresponding to the second item rolled to this area, which is convenient for the user to directly preview the video contents, and is closer to the use habit of the user.

In one embodiment, the user may select whether to automatically load and play the video when displaying the video list. The terminal equipment determines whether to play the video in the previewing area of the item according to a selection instruction received when displaying the video list. When a first selection instruction of playing the video in the previewing area of the item is received, a function of playing the corresponding video in the previewing area of the item is enabled; at this moment, the corresponding video will be automatically played in the previewing area of the preset item when opening the video list; and when the user controls the item in the video list to roll up and down, the corresponding video is played in the previewing area of the item rolled to the preset display area. When a second selection instruction of forbidding playing the video in the previewing area of the item is received, a function of playing the corresponding video in the previewing area of the item is disabled; at this moment, the corresponding previewing pictures will be displayed in the previewing areas of the items when opening the video list; and when the user controls the item in the video list to roll up and down, the corresponding previewing pictures are displayed in the previewing area of the items only.

In the embodiment, the user may further select to enable and disclose the function of playing the video in the previewing area of the item, which respects the right of selection of the user, so that the friendly degree of the video application is improved.

The embodiments of the present disclosure are further explained hereinafter through application scenarios.

The embodiment of the present disclosure may be developed on the basis of a software development kit (SDK) of an Android operating system to add a switch of whether to automatically play the corresponding video in the previewing area of item in application settings. This switch just executes different sentences according to the value of an expression. The pursuant values for the switch to determine are saved in a SharePreference file. SharePreference is a normal data storage manner in an Android application, which is essentially an xml file for saving small amounts of data in the type of configuration files in generally, and has the characteristics of simplicity and convenience. For example, if the user selects to enable the function of playing the video in the previewing area of the item, the value saved in the SharePreference file is set as 1; if the user selects to disable the function of playing the video in the previewing area of the item, the value saved in the SharePreference file is set as 0.

When the terminal equipment opens a video list page (i.e., ListView control), the display effects are controlled according to the value saved in the SharePreference file. Items may be displayed by the ListView control using four different views. The items may be composed into a row with or without a row header through this control, and accompanying icons and texts are displayed. The ListView control may be used to organize the items of a list called as ListItem objects into one of the four different views as follows: 1. big (standard) icon, 2. small icon, 3 list, and 4, report form. A View attribute determines to the view used by the control to display the items in the list. A LabelWrap attribute may also be used to control whether labels associated the items in the list can be displayed with line breaks. Moreover, a sequencing method for the items in the list may be managed and the appearances of the items may be selected as well.

If the value saved in the SharePreference file is 1, then the video of a preset item of the ListView control is automatically loaded, and a MediaPlay service is enabled to automatically play the video. Corresponding previewing pictures are displayed in the previewing areas of other items. The preset item is usually set as the initial item of the ListView control. After the video list is opened, the video is automatically loaded and played in the list area of the initial item.

The user slides the video list page up and down through a gesture operation, to roll each item in the video list. When the item in the video list stops rolling, the display positions of the currently displayed items in the screen are acquired, the item rolled to the preset display area is determined, and the playing of the video corresponding to the item is started in the previewing area of the item. At this moment, the corresponding previewing pictures are displayed in the previewing areas of other items (including the preset item), and the video is only played in the previewing area of the item rolled to the preset display area in the frame. The playing of the video of the preset item may be stopped when the item of the video list starts rolling, and may also be stopped when starting playing the video of the item rolled to the preset display area. Wherein, the preset display area is usually arranged above the transverse middle line of the screen; during determination, the items with the display positions covering the preset display area or the items with the display positions located in the preset display area may be determined.

When the terminal equipment opens the video list page (i.e., ListView control), if the value saved in the SharePreference file is 0, then the corresponding previewing pictures are displayed in the previewing area of each item, and the video will not be played automatically.

Embodiments of devices of the present disclosure are described hereinafter, which may be used for performing the foregoing method according to the embodiments of the present disclosure.

FIG. 5 is a device for automatically playing video list provided by the embodiment of the present disclosure, including: a display module 30 and a first processing module 31.

The display module 30 is configured to, when an instruction for opening a video list is detected, display the video list, the video list is an interface object for interacting with a user, and includes one or more items, and each item includes a previewing area.

The first processing module 31 is configured to play the video of a first item in the previewing area of the first item of the video list, and simultaneously display corresponding previewing pictures in the previewing areas of other items.

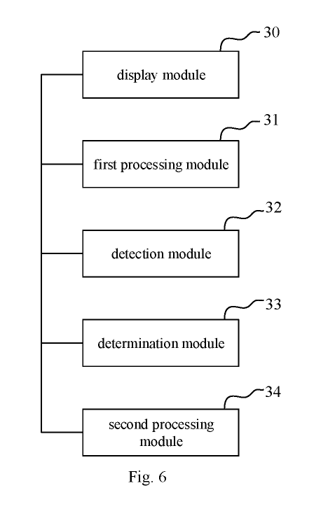

In one embodiment, the device as shown in FIG. 6 further includes: a detection module 32, a determination module 33 and a second processing module 34.

The detection module 32 is configured to detect a slide operation with respect to the video list.

The determination module 33 is configured to, when the item in the video list stops rolling, determine a second item rolled to a preset display area.

The second processing module is 34 configured to play the video of the second item in the previewing area of the second item, and simultaneously display corresponding previewing pictures in the previewing areas of other items.

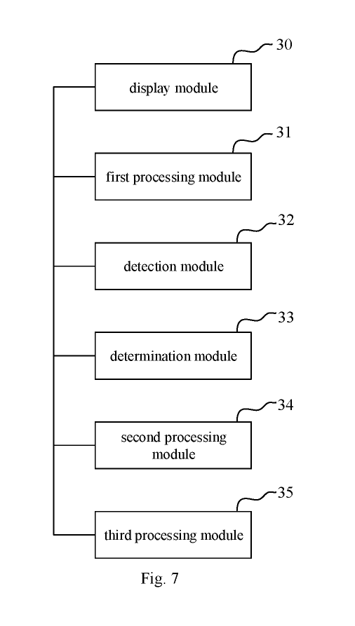

In one embodiment, the device as shown in FIG. 7 further includes: a third processing module 35.

The third processing module 35 is configured to, when the item in the video list stops rolling, stop playing the video of the first item.

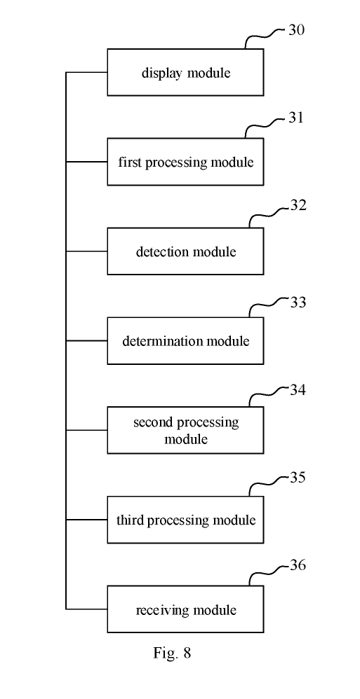

In one embodiment, the device as shown in FIG. 8 further includes: a receiving module 36.

The receiving module 36 is configured to receive a selection instruction of playing the video in the previewing area of the item.

Furthermore, each functional module above in the embodiments of the present disclosure can be implemented through a hardware processor.

The embodiment of the present disclosure also provides a device for automatically playing video list, including: a processor and a memory.

The memory is used for storing instructions executable by the processor.

Wherein the processor is configured to: when an instruction for opening a video list is detected, display the video list, the video list being an interface object for interacting with a user, and including one or more items, and each item including a previewing area; and play the video of a first item in the previewing area of the first item of the video list, and simultaneously display corresponding previewing pictures in the previewing areas of other items.

In one embodiment, the processor is further configured to: detect a slide operation with respect to the video list; when the item in the video list stops rolling, determine a second item rolled to a preset display area; and play the video of the second item in the previewing area of the second item, and simultaneously display corresponding previewing pictures in the previewing areas of other items.

In one embodiment, after detecting the slide operation with respect to the video list, the processor is further configured to: when the item in the video list stops rolling, stop playing the video of the first item.

In one embodiment, the preset display area is arranged above the transverse middle line of a screen.

In one embodiment, before displaying the video list when the instruction for opening a video list is detected, the processor is further configured to: receive a selection instruction of playing the video in the previewing area of the item.

In one embodiment, the first item is the initial item of the video list.

The device embodiments described above are only exemplary, wherein the units illustrated as separation parts may either be or not physically separated, and the parts displayed by units may either be or not physical units, i.e., the parts may either be located in the same plate, or be distributed on a plurality of network units. A part or all of the modules may be selected according to an actual requirement to achieve the objectives of the solutions in the embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer device (which may be a personal computer, a server, or a network device so on) to execute the method according to each embodiment or some parts of the embodiments.

It should be finally noted that the above embodiments are only configured to explain the technical solutions of the present disclosure, but are not intended to limit the present disclosure. Although the present disclosure has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the claims.

What is claimed is:

1. A method for automatically playing video list, comprising:
when an instruction for opening a video list is detected, displaying the video list, the video list an interface object for interacting with a user, and comprising one or more items, and each item comprising a previewing area;
playing the video of a first item in the previewing area of the first item of the video list, and simultaneously displaying corresponding previewing pictures in the previewing areas of other items.

2. The method according to claim 1, wherein the method further comprises:
detecting a slide operation with respect to the video list;
determining a second item rolled to a preset display area when the item in the video list stops rolling; and
playing the video of the second item in the previewing area of the second item, and simultaneously displaying corresponding previewing pictures in the previewing areas of other items.

3. The method according to claim 2, wherein after the detecting the slide operation with respect to the video list, the method further comprises:
stopping playing the video of the first item when the item in the video list stops rolling.

4. The method according to claim 2, wherein the preset display area is arranged above the transverse middle line of a screen.

5. The method according to claim 1, wherein when the instruction for opening a video list is detected before displaying the video list, the method further comprises:
receiving a selection instruction of playing the video in the previewing area of the item.

6. The method according to claim 1, wherein the first item is the initial item of the video list.

7. A device for automatically playing video list, comprising:
a display module configured to, when an instruction for opening a video list is detected, display the video list, the video list being an interface object for interacting with a user, and comprising one or more items, and each item comprising a previewing area; and
a first processing module configured to play the video of a first item in the previewing area of the first item of the video list, and simultaneously display corresponding previewing pictures in the previewing areas of other items.

8. The device according to claim 7, wherein the device further comprises:
a detection module configured to detect a slide operation with respect to the video list;
a determination module configured to determine a second item rolled to a preset display area when the item in the video list stops rolling; and
a second processing module configured to play the video of the second item in the previewing area of the second item, and simultaneously display corresponding previewing pictures in the previewing areas of other items.

9. The device according to claim 8, wherein the device further comprises:
a third processing module configured to stop playing the video of the first item when the item in the video list stops rolling.

10. The device according to claim 7, wherein the device further comprises:
a receiving module configured to receive a selection instruction of playing the video in the previewing area of the item.

11. A device for automatically playing video list, comprising:
a processor; and
a memory for storing instructions executable by the processor;
wherein the processor is configured to:
when an instruction for opening a video list is detected, display the video list, the video list being an interface object for interacting with a user, and comprising one or more items, and each item comprising a previewing area; and
play the video of a first item in the previewing area of the first item of the video list, and simultaneously display corresponding previewing pictures in the previewing areas of other items.
